(19) United States
(12) Patent Application Publication
(10) Pub. No.: US 2006/0230625 A1
(43) Pub. Date: Oct. 19, 2006

(54) Water display stand

(75) Inventors: Heather Hughes, Peoria, IL (US); James Christopher Colwell, Peoria, IL (US); Lawrence P. Heren, East Peoria, IL (US); Linda J. McMahill, Chillicothe, IL (US); Michelle Hardesty, Dunlap, IL (US)

Correspondence Address: BRINKS HOFER GILSON & LIONE, P.O. BOX 10395, CHICAGO, IL, 60610, US

(73) Assignee: L.R. NELSON CORPORATION, PEORIA, IL (US)

(21) Appl. No.: 11/354,693

(22) Filed: Feb. 15, 2006

Related U.S. Application Data
(60) Provisional application No. 60/653,642, filed on Feb. 17, 2005.

(51) Int. Cl. B60K 37/00

(52) U.S. Cl. 33/333

(57) ABSTRACT

A portable water display platform and system. The platform is adjustable in height, and is configured for displaying an object such as, for example, a statuette or fountain in a body of water such as a decorative pond.

### CROSS REFERENCE TO RELATED APPLICATION

This application claims priority to U.S. Provisional Application Ser. No. 60/653,642, filed Feb. 16, 2005.

### TECHNICAL FIELD

This invention relates generally to water fountains and displays, and in particular, to a portable and adjustable stand for supporting a water fountain or a decorative statuette.

### BACKGROUND

A conventional portable water fountain assembly typically includes a decorative statuette attached to a self-contained water basin and pump for re-circulating water. Existing portable water fountain assemblies can be used in indoor and/or outdoor environments, but they generally require particular water basins and can not be used with other reservoirs of water. It is desirable to be able to use portable water fountains without such water basins, for example in bodies of water such as ponds and lakes, including small decorative ponds of the type known for use in what are commonly called “backyard water gardens.”

It is also known to provide floating fountains in ponds and lakes for water aeration and landscaping effects. Such pond or lake fountains are typically provided with a spray head connected to a submersible pump for producing a desired spray effect. However, existing pond or lake fountains cannot support a removable decorative statuette for use therewith. It is desirable to provide a portable display stand that configured to support a removable display such a fountain or decorative statuette.

### BRIEF SUMMARY

In one aspect, the present invention includes a portable water display stand configured to hold a water display such as a fountain or statuette. The stand includes an upper platform that is adjustable in height and that has an attachment means for attaching a display thereto. The platform optionally includes accessory-mounting features. The adjustable height feature may include adjustable legs and/or a buoyant platform attached to a base by an adjustable-height connector. The water display stand optionally includes a plate for supporting a pump (e.g., for use when the display being supported is a fountain. In another aspect, the invention includes a portable display stand placed in a closed body of water such as, for example a decorative pond or watercourse, wherein a platform of the stand preferably is mounted about even with water level.

### BRIEF DESCRIPTION OF THE DRAWINGS

FIG. 1 is a perspective view of a water display stand in accordance with a first embodiment of the present invention, shown in a body of water;

FIG. 2 is a top perspective view of a platform of a water display stand in accordance with a second embodiment of the present invention;

FIG. 3 is a partially cut-away perspective view of a groove on the platform of FIG. 2 for securing a display to the platform;

FIG. 4 is a perspective view of a bracket for securing a supporting leg to the platform of FIG. 2;

FIG. 5 is a partially cut-away perspective view of a socket structure for receiving the bracket of FIG. 4;

FIG. 6 is a side view, in cross-section, of the bracket of FIG. 4 received in the socket structure of FIG. 5, taken along line 6-6 in FIG. 5;

FIG. 7 is a bottom view of the platform of FIG. 2 illustrating stiffening ribs formed on the bottom of the platform;

FIG. 8 is a perspective view of an accessory holder slot of the platform of FIG. 2;

FIG. 9 is a side view, in partial cross section, of the accessory holder slot of FIG. 8;

FIG. 10 is a partial top perspective view of the platform of FIG. 2 illustrating accessory holes;

FIG. 11 is a top view of the platform of FIG. 2 illustrating a configuration for the accessory holes of FIG. 10;

FIG. 12 is a perspective view of an accessory cup for mounting onto the acessory holder slot of FIG. 8;

FIG. 13 is a top view of the accessory cup of FIG. 12;

FIG. 14 is a partial perspective view of the accessory cup of FIG. 12 illustrating a clasping member;

FIG. 15 is a partial top end view of the clasping member of FIG. 14;

FIG. 16 is a perspective view of an accessory cup of FIG. 12 illustrating an accessory inserted therein;

FIG. 17 is a side view of an accessory cup of FIG. 12 illustrating an accessory inserted therein;

FIG. 18 is a perspective view of the accessory cup of FIG. 12 illustrating an accessory inserted therein;

FIG. 19 is partial perspective view of the accessory cup of FIG. 12, illustrating a clasping member;

FIG. 20 is a partial perspective rear-side view of a locking wing of the clasping member of FIG. 19;

FIG. 21 is a side view of a water display platform in accordance with a third embodiment of the present invention;

FIG. 22 is a top perspective view of a plate for supporting a pump for use with the platform of FIG. 21;

FIG. 23 is a bottom perspective view of the plate of FIG. 22;

FIG. 24 is a perspective view of a hook for securing the plate of FIG. 22 to the platform of FIG. 21;

FIG. 25 is perspective view of a foot for use with a water display platform in accordance with the present invention;

FIG. 26 is side view of the foot of FIG. 25;

FIG. 27 is a bottom perspective view of a platform of FIG. 2 illustrating level-indicating structure attached thereto;

FIG. 28 is a perspective view of a floating water display stand in accordance with a fourth embodiment of the present invention, shown in a body of water;

FIG. 29 is a perspective view of a floating platform of the water display stand of FIG. 28 illustrating a set of floating accessory holders attached thereto;

FIG. 30 is a perspective of another floating platform embodiment illustrating another set of accessory holders attached thereto;

FIG. 31 is a top view of the floating platform of FIG. 30, showing a laterally pivotable accessory holder;

FIG. 32 is a partial perspective view of an extension arm embodiment of the accessory holders of FIG. 30;

FIG. 33 is a partial perspective view of another extension arm embodiment of the plant holders of FIG. 30;

FIG. 34 is a perspective view of another floating platform embodiment; and

FIG. 35 is a perspective view of yet another floating water display stand embodiment.

### DETAILED DESCRIPTION OF THE DRAWINGS AND THE PRESENTLY PREFERRED EMBODIMENTS

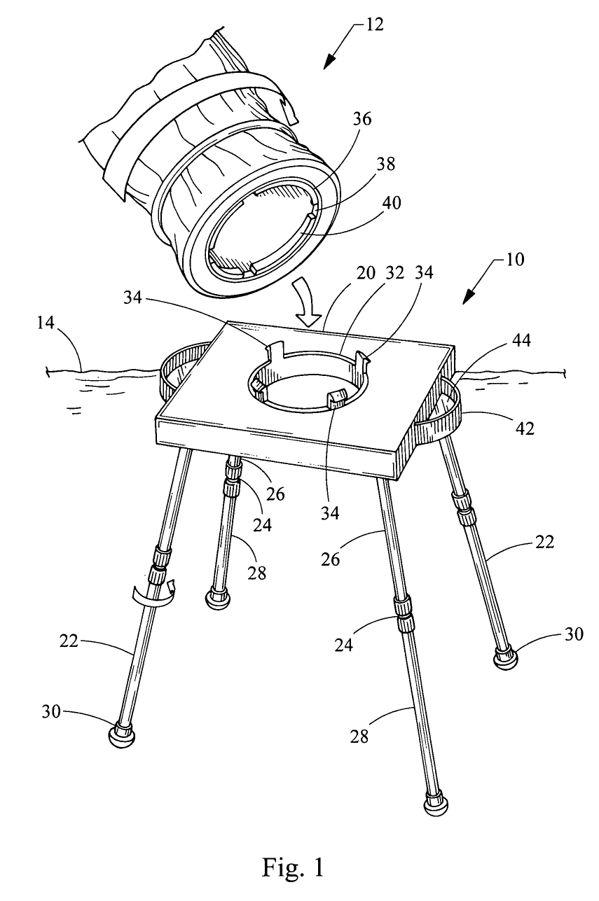

Referring to FIG. 1, there is shown a water display stand 10 according to an embodiment of the present invention for removably securing a display 12, such as, for example a water fountain, a plant-pot, or a decorative statuette, relative to a water level 14. Water display stands of the present invention preferably are configured for use in an enclosed body of water such as a decorative water garden (including, for example, a pond and/or a closed waterway).

The stand 10 includes a generally rectangular platform 20 supported by a plurality of telescoping legs 22, each having an adjustable length. In the present embodiment, the four telescoping legs 22 are securely attached to the underside of the platform 20 at the corners of the platform 20. It will be appreciated that the number and location of the telescoping legs 22 may be varied so as to provide stable support for the platform 20 depending on the shape of the platform 20 and upon the shape of the terrain where the stand 10 is to be placed. It will also be appreciated that the legs 22 may be provided with fixed lengths instead of adjustable lengths.

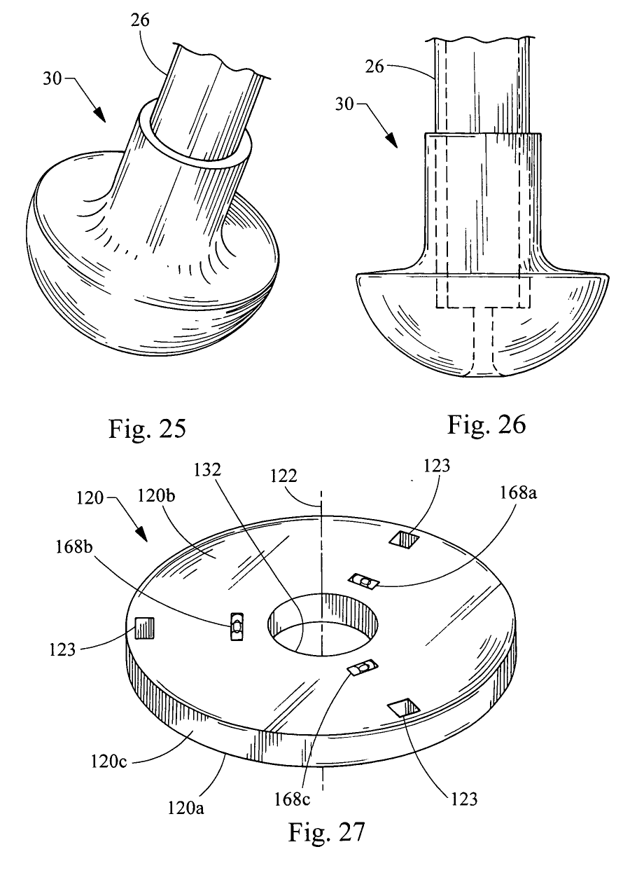

Each telescoping leg 22 includes a collar 24 for adjusting the length of the leg and locking the leg into position. In this way, a telescoping leg 22 can be individually raised and lowered to level the platform 20 on uneven surfaces and to position the display 12 at a desired height relative to the water level 14 (e.g., at, above, or below water level, but preferably at about water level). The collar 24 connects the upper and lower leg members 26, 28 of a telescoping leg 22 in a manner known to one of ordinary skill in the art. For example, a collar 24 having a threaded inner portion may cooperate in a compression fitting with a threaded portion of the lower leg member 28 to allow the upper leg member 26 to selectively telescope axially in and out of the lower leg member. The ends of the upper leg members 26 opposite the collar 24 may be integrally molded with the platform 20 or may be attached by different means (such as, for example, a threaded attachment, adhesive, or a nut-bolt arrangement). The ends of the lower leg members 26 opposite the collar 24 may be provided with rubber feet or caps 30, an example of which is shown in FIGS. 25 and 26. The feet or caps 30 preferably are configured to decrease the likelihood of the stand 10 slipping or damaging a pond liner.

In the embodiment illustrated in FIG. 1, the platform 20 includes a central opening 32 formed therein so as to receive the display 12. A pump (not shown) disposed under the platform 20 may be connected to the display 12 using a water supply tube (not shown) that is passed through the opening 32 (e.g., if the display 12 is a fountain). The opening 32 defines a circumferential shoulder having a set of locking bayonets 34 formed thereon. The bayonets 34 preferably have an L-shaped cross section and may be molded integrally with the platform 20, or they may attached to the platform 20 using other fastening means, such as, for example, adhesive materials and/or mechanical fasteners such as dowels, bolts, pegs, rivets, or screws.

The bayonets 34 may be received in a circular locking ring 36 provided on the underside of the display 12 such that a rotation of the display 12 in a first direction secures the bayonets 34 within the locking ring 36 for securing the display 12 to the platform 20. A subsequent rotation of the display 12 in a second direction opposite the first direction disengages the bayonets 34 from the locking ring 36 to allow the display 12 to be removed from the platform 20. For example, as illustrated in FIG. 1, multiple bayonets 34 are evenly spaced around the periphery of the opening 32 so as to correspond to a set of concentric arced grooves 38 formed on the locking ring 36. Each groove 38 includes a tab 40 formed thereon for axially engaging a bayonet 34 when the display 12 is rotated in the first direction. When the display is rotated in the second direction, the bayonets 34 are released from the tabs 40.

As can be appreciated, such an arrangement allows different displays 12 easily to be exchanged and used with the stand 10. In addition, a user readily can remove the display 12 from the platform 20 and adjust the telescoping legs 22 in order to facilitate moving the stand 10 to a different location.

In the embodiment shown in FIG. 1, one or more accessory holders 42 may be provided at the sides of the platform 20 around its periphery. In the illustrated embodiment of the water display stand 10, accessory holders 42 each include a semi-circular receptacle 44 having a flat surface for attachment to the platform 20 using a fastening means (such as, for example, reusable adhesive materials, hook and loop fasteners (e.g., VELCRO® brand fasteners), straps, tapes or mechanical fasteners such as dowels, bolts, pegs, rivets, or screws). It will be appreciated that accessory devices, such as, for example, light fixtures or sound speakers, may be provided with connectors that are received in the receptacles 44 to removably secure the accessory devices in the accessory holders 42. For example, a receptacle 44 may have a threaded opening formed therein which is shaped to receive and threadedly engage a threaded portion extending from an accessory device.

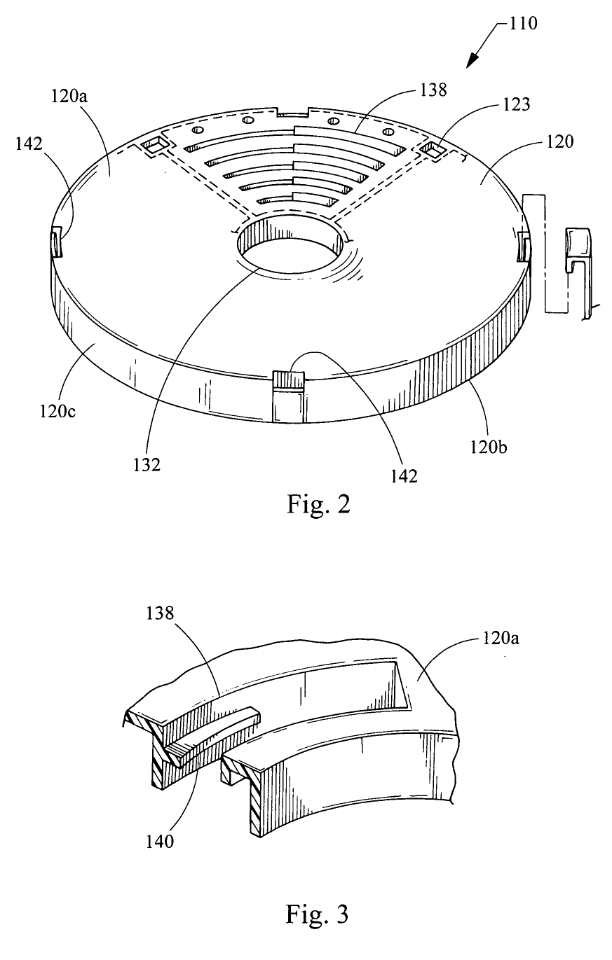

According to another embodiment of the present invention as shown in FIGS. 2-6 and 27, a water display stand 110 for removably securing a display (not shown) relative to a water level includes a circular platform 120 supported by a plurality of telescoping legs (not shown) having an adjustable length. The platform 120 includes a top surface 120a and a bottom surface 120b with an outer circular edge face 120c therebetween as shown in FIG. 2. An opening 132 is formed centrally in the platform 120 and extends therethrough for receiving a water supply tube (not shown) that may connect a pump (not shown) located under the platform 120 to the display (e.g., if the display is a fountain).

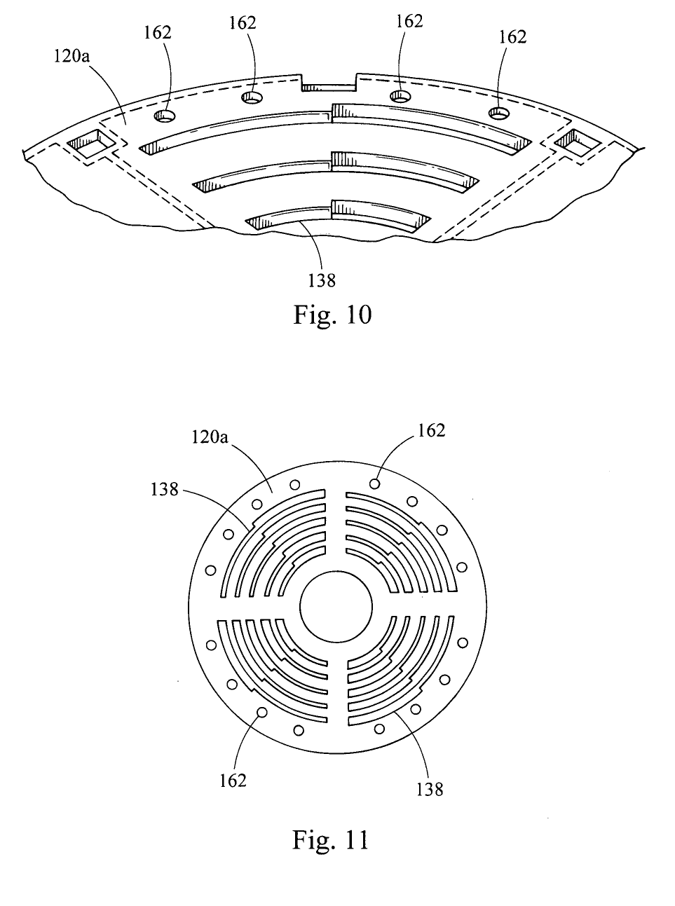

The top surface 120a of the platform 120 includes at least one concentric sets of arc-shaped grooves 138 formed therein, as shown in FIG. 2 (multiple sets of arced grooves may be used as shown in FIG. 11), for receiving locking bayonets provided on the underside of a display to secure the display to the platform 120. The different placements and sizes of the individual grooves provides for ease of mounting different sized displays to the platform 120. Each set of the grooves includes a plurality of spaced apart grooves 138 circumferentially formed around the opening 132 at a predetermined distance from the center of the platform 120 so as to correspond to the location of complementary bayonets circumferentially arranged on the underside of a display (not shown). In this way, the platform 120 can accommodate different displays having locking bayonets arranged at concentrically different locations. Each arced groove 138 includes a tab 140 formed thereon for axially engaging a bayonet when the display is rotated in a first direction. When the display is rotated in a second direction opposite the first direction, the bayonets of the display are released from tabs 140 to allow the display to be removed from the platform 120 for increased portability of the platform and interchangeability of the display.

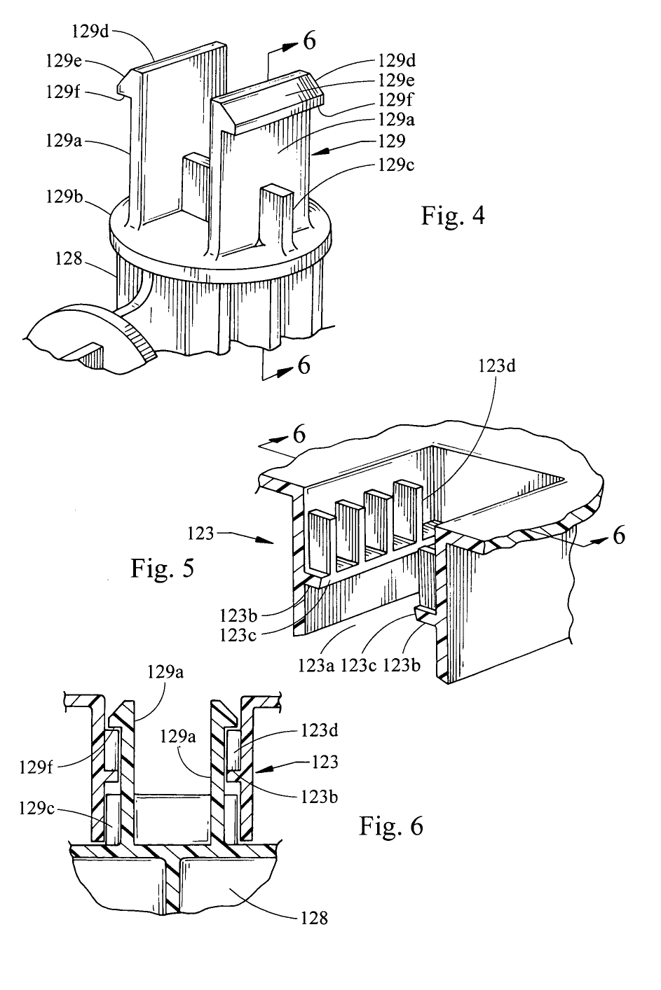

Telescoping legs preferably are mounted to the platform 120 at evenly spaced circumferential locations on the bottom surface 120b. Each telescoping leg includes a lower leg member (not shown) and an upper leg member 128 (see FIG.4) that are connected by a collar (not shown) in a manner known to one of ordinary skill in the art for adjusting the length of the leg and locking the leg in a desired position as described above. The ends of the lower leg members opposite the collar may be provided with rubber caps (e.g., to minimize the likelihood the stand 110 from slipping or damaging a pond liner.

FIGS. 4-6 and 27 show one mechanical attachment means for mounting legs to a platform (such as, for example, platform 120) of a water display stand of the present invention. The upper ends of the upper leg members 128 have brackets 129 fixed thereto which are received in sockets 123 secured to the bottom surface 120b of the platform 120 as shown in FIGS. 4-6 and 27. Each bracket 129 includes a pair of parallel opposed feet 129a extending vertically from a platform portion 129b. Proximal end portions of feet 129a have supporting shoulder portions 129c formed on outer surfaces thereof and extending from the platform portion 129b. Flanges 129d having inwardly tapered upper surfaces 129e and lower abutment surfaces 129f are formed on distal ends of the feet 129a.

The feet 129a are received in openings 123a formed in sockets 123 to interlock the brackets 129 and the sockets 123. Each opening 123a includes a pair of lateral projections 123b formed on opposing inner faces thereof. Each of the lateral projections 123b is provided with outwardly tapered distal edges 123c and a plurality of vertical walls 123d formed on the upper surface thereof. In this way, the outwardly tapered side edges 123c guide the flanges 129d such that the feet 129a are resiliently deformed inwardly when a bracket 129 is inserted into a socket 123. As the bracket 129 is inserted further into the socket 123, the flanges 129d are displaced above the distal ends of walls 123d until the shoulder portions 129c abut against the lower surfaces of lateral projections 123b. In this position, the feet 129a flex outwardly to bring the lower abutment surfaces 129f of the flanges 129d into locking engagement with the distal ends of walls 123d. This arrangement secures the bracket 129 in the socket 123 to firmly mount the telescoping legs to the platform 120.

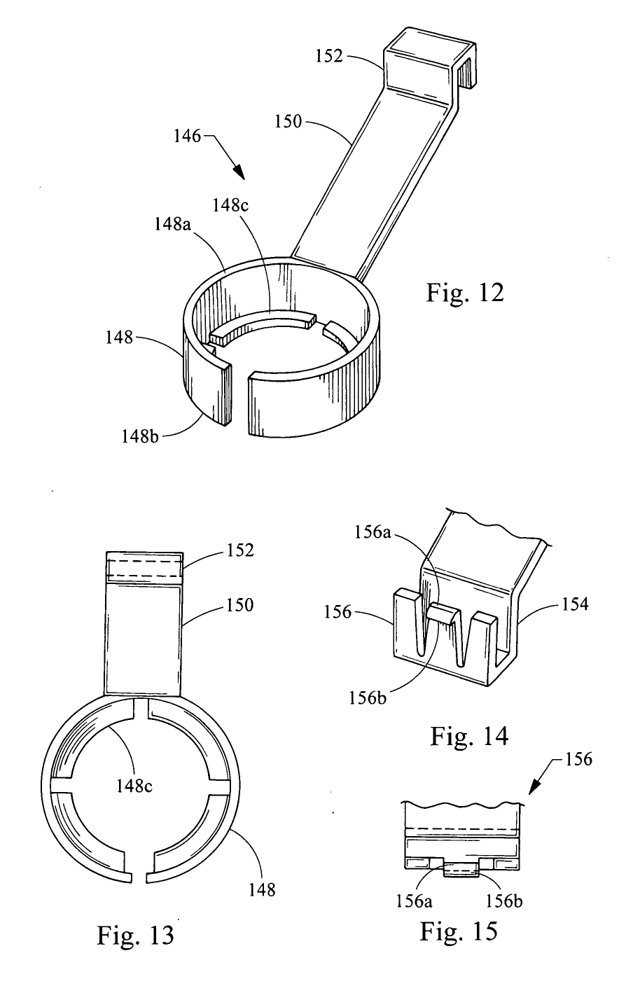

As shown in FIGS. 2, 8 and 9, in the present embodiment, the platform 120 also includes a plurality of spaced-apart accessory holder slots 142 formed circumferentially on the outer circular face 120c. Each slot 142 preferably includes a mounting lip 144 that is generally continuous with the circular face 120c, but with a top edge below the top surface 120a (see, e.g., FIGS. 2 and 8). It will be appreciated that the height of the mounting lips 144 is less than the height of the circular face 120c by a predetermined amount so as to allow an accessory cup structure 146 to be mounted substantially flush with the top surface 120a of the platform (see, for example, FIGS. 9 and 12).

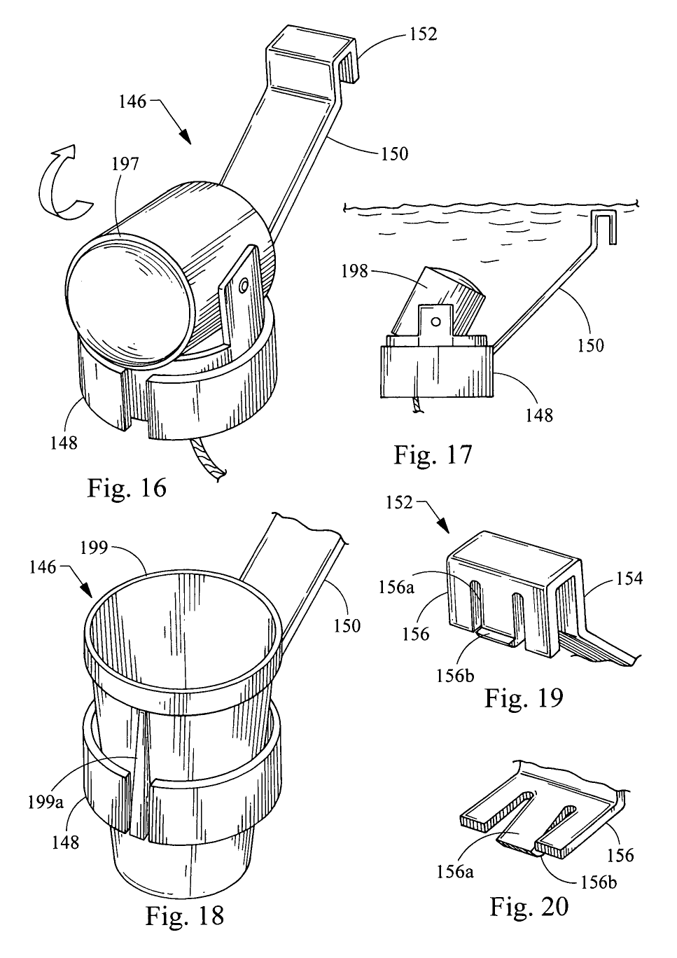

Referring next to FIGS. 12-20, an accessory cup structure 146 is shown, which includes a slotted ring 148 and a mounting arm 150 fixed to an outer top edge 148a and extending outwardly above the ring 148. The slotted ring 148 is provided with a circumferential slotted shelf 148c around its inner bottom edge 148b for supporting an accessory device received in the ring 148. For example, as shown in FIGS. 16-18, an accessory device having a constant diameter (e.g., a pivotable light 197) may be supported on the shelf 148c. An accessory device having a generally conical profile (e.g., a plant pot 199 having a flange 199a engaging the slot in ring 148) may be received in the ring 148 such that the shelf 148c abuts firmly against the sides of the accessory device to support it. In this way, a light fixture having a swivel mount, as shown in FIGS. 16 and 17, can be received and positioned in the accessory cup 146 to illuminate the fountain or statuette being displayed.

The arm 150 includes an inverted U-shaped clasping member 152 formed at one end thereof for removably mounting the accessory cup 146 in the accessory holder slot 142 (see, e.g., FIGS. 2, 8 and 9) of the platform 120. The arm 150 may be angled downward from the clasping member 152 (e.g., to hold an accessory below water level), or may extend relatively perpendicular or upwardly angled therefrom (e.g., to hold an accessory at or above water level). The clasping member 152 includes a pair of generally parallel and laterally disposed inner and outer side walls 154 and 156 connected by a top portion 158 as shown in FIGS. 14-15 and 19-20. The outer side wall 156 is notched to form a resilient locking wing 156a. FIG. 20 shows a rear-side view of the inner side wall 156 with the locking wing 156a flexed out of alignment therewith.

When mounting the accessory cup 146 in a slot 142, the slot mounting lip 144 is received between the side walls 154 and 156 of the clasping member and the locking wing 156a resiliently contacts the rear surface of the slot 142, as shown in FIG. 9. A flange 156b (which may be, for example, angular as is shown in FIG. 14, or rounded as is shown in FIG. 19) is provided at the distal end of the locking wing 156a and preferably engages a lock tab 160 formed on the bottom surface 120b of the platform 120 so as to interlock the accessory cup 146 and the platform 120. The locking wing 156a is adapted to be manually depressed by urging the flange 156b out of engagement with the lock tab 160 so as to allow the clasping member 152 to be removed from the slot 142. In this way, the accessory cups 146 can be readily removed from the platform 120 for its increased portability.

In the embodiment shown in FIGS. 10-11, the platform 120 is also provided with a set of accessory holes 162 formed circumferentially on the top surface 120a of the platform 120. Preferably, the accessory holes 162 are formed between the outermost grooves 138 and the outer edge of the top surface 120a. It will be appreciated that accessory devices, such as light fixtures, may be provided with connectors that are received in the accessory holes 162 to removably secure the accessory devices to the platform 120. For example, an accessory hole 162 may have a threaded opening which is shaped to receive and threadedly engage a complementarily threaded portion extending from an accessory device. Accessory holes 162 having different diameters may be provided for mounting different accessory devices on the platform 120 as shown in FIG. 10.

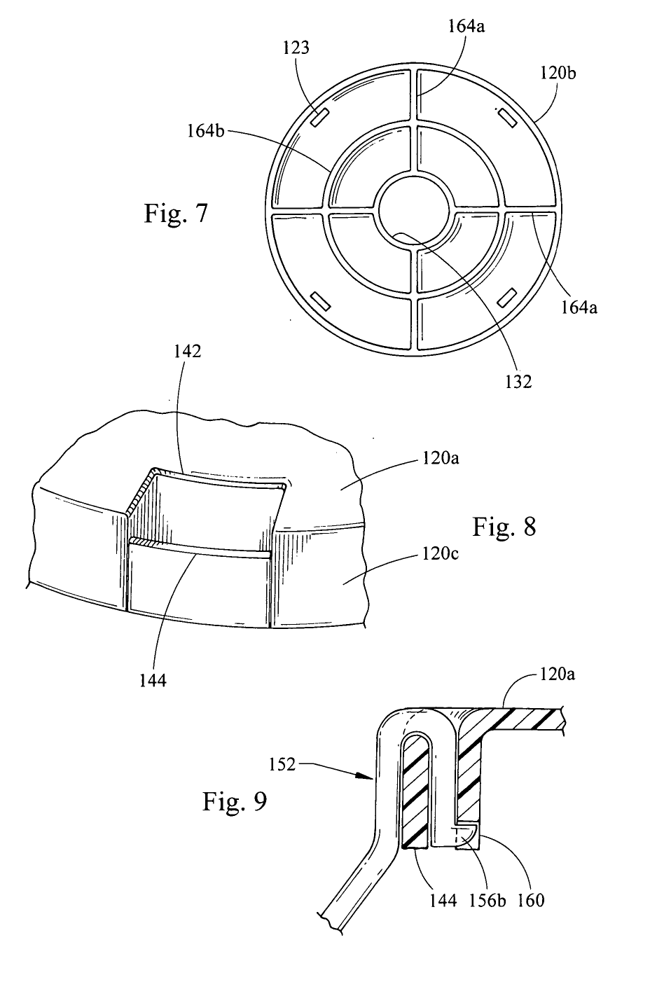

As shown in FIG. 7, the platform 120 may also be provided with a set of ribs 164 formed on the bottom surface 120b of the platform 120 to increase the rigidity of the platform. For example, a set of four ribs 164a may be integrally formed on the bottom surface 120b evenly spaced around the central opening 132 and extending axially away from the central opening to the outer edge of the bottom surface. The platform 120 may be also provided with a circular rib 164b on the bottom surface 120b extending across the axial ribs 164a.

As shown in FIG. 27, the platform 120 may also be provided with a set of level indicating structures, such as bubble levels, which are attached to the bottom surface 120b circumferentially around the central opening 32 for leveling the platform 120 on uneven ground surfaces. For example, three bubble levels 168 may be attached at evenly spaced locations around the central opening 32, including a first bubble level 168a oriented perpendicular to a longitudinal center line 122 of the platform 120, a second bubble level 168b oriented parallel to the longitudinal center line 122 and a third bubble level 168c oriented at approximately 45 degrees to the longitudinal center line 122. In this way, the telescoping legs can be individually adjusted such that the bubble levels 168 indicate a level surface, thereby leveling the platform 120. If the platform is to be mounted at water level in a body of water, the water surface itself may be used during leveling of the platform.

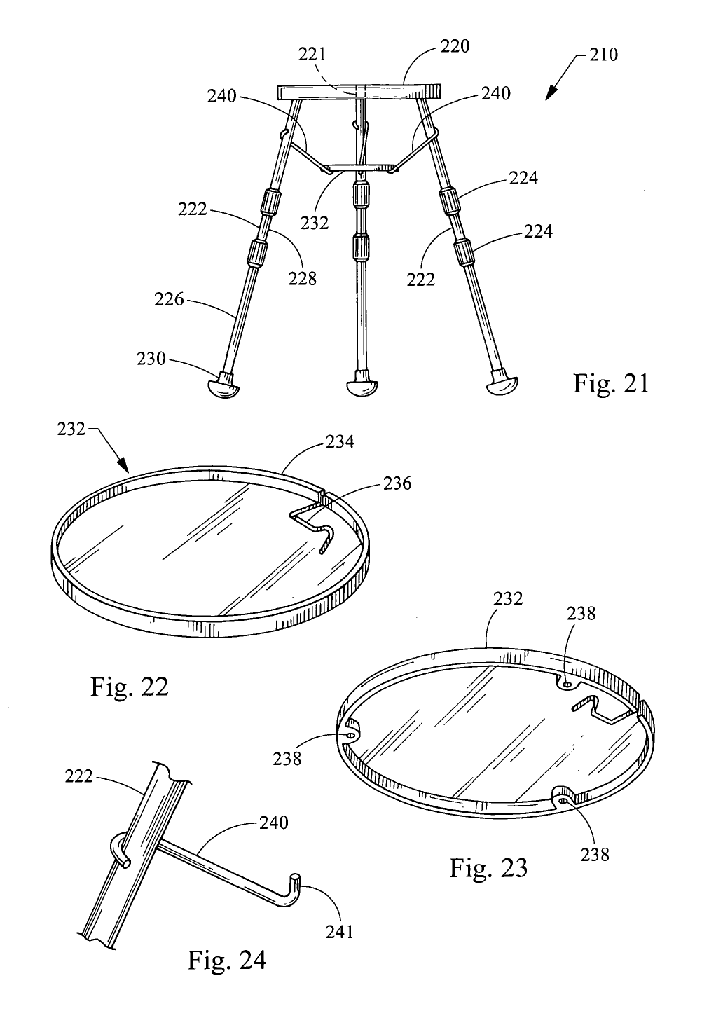

According to another embodiment of the present invention, as shown in FIGS. 21-24, a water display stand 210 for removably securing a display (not shown) includes a platform 220 supported by a plurality of telescoping legs 222, each preferably having an adjustable length. An opening 221 is formed centrally in the platform 220 and extends therethrough for receiving a water supply tube (not shown) that may connect a pump (not shown) positioned beneath the platform 220 to the display.

The telescoping legs 222 preferably are mounted to the platform 220 at circumferential locations on the bottom surface 220b of the platform. Each telescoping leg 222 includes a plurality of leg members 226, 228 and 230 connected by collars 224 in a manner known to one of ordinary skill in the art for adjusting the length of the leg and locking the leg in a desired position. The distal ends of the lower leg members 226 may be provided with rubber caps 230.

A plate 232 is provided for supporting a pump or other ancillary unit (e.g., light, battery assembly) below the platform 220. The top surface of the plate 232 includes a guard 234 formed peripherally thereon to prevent the pump from sliding off the plate. The plate 232 also includes a curved slot 236 formed therethrough at its edge for receiving a power cord. The bottom surface of the plate 232 is provided with a set of openings 238 corresponding to the legs 222. Each opening 238 is configured to receive an upwardly curved end 241 of a hook member 240. The opposite end of the hook member 240 is shaped so as to firmly fit around an upper leg member 230. This allows the plate 232 to be attached to and supported in a suspended position by the upper leg members 230 below the platform 220. Alternatively, the plate 232 may be attached to the platform 220, or suspended from cross-members (not shown) provided between the legs 222.

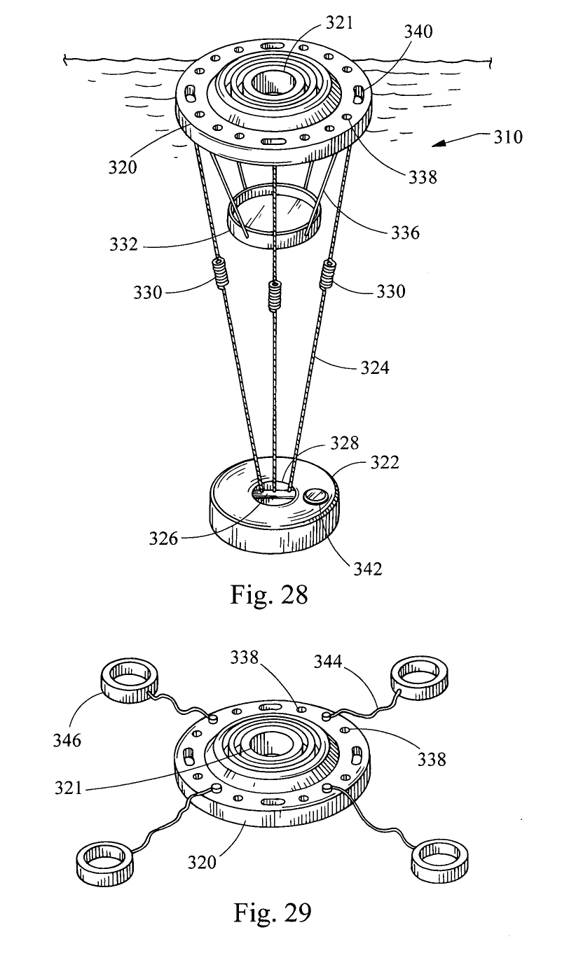

According to other embodiments of the present invention, as shown in FIGS. 28-35, a water display stand of the present invention may include an adjustable-height floating platform anchored by a base. FIG. 28 shows a water display stand 3 1 0 including a floating platform 320 configured for mounting of a removable display (not shown) and anchored to a base 322. The platform 320 may be constructed of a buoyant material or may be an air filled structure, such as, for example, a blow molded structure that it is capable of floating in water. It will be appreciated that a floating platform can be formed integrally with a display such that the platform and the display are a unitary arrangement. The platform 320 preferably includes ballast that provide for keeping it relatively level and in a desired orientation when a display is mounted thereto. The base 322 preferably is a structure that is sufficiently heavy to anchor the platform and the display, for example, a cast metal weight or a blow molded container filled with a loading material such as water, sand or lead shot. A fill cap 342 may be provided on the base 322 to allow the base 322 to be filled with the loading material. Alternatively, the base 322 may be a screw type fastener which can be firmly secured in the ground on the bottom of a lake or pond. It should be appreciated that the floating platform 320 can also be used without a base 322 such that it is floating freely.

As shown in FIG. 28, an opening 321 is formed centrally in the platform 320 and extends therethrough for receiving a water supply tube (not shown) that connects a pump (not shown) positioned under the platform 320 to the display. As described above (with reference to FIGS.2 and 11), the top surface of the platform 320 may include multiple concentric arc-shaped grooves formed therein for receiving locking bayonets provided on the underside of a display to secure the display to the platform 320. Alternatively, the top surface of the platform 320 may include a set of L-shaped bayonets or other connecting structure(s) formed on the circumferential shoulder of the opening 321 which are configured to attach to complementary attaching structure(s) provided on the underside of a display.

In the embodiment shown in FIG. 28, the platform 320 is also provided with a set of accessory holes 338 formed circumferentially on the platform 320 for mounting different accessory devices thereon, as described above. For example, the accessory holes 338 may receive potted plants or other ornamental features for decorating the platform 320. Alternatively, as shown in FIG. 29, a plurality of tethering lines 344 may be secured at one end in the accessory holes 338 for connecting floating accessories to the platform 320. Each floating accessory preferably includes a mounting structure 346, such as a ring constructed of buoyant material for securing an ornamental feature therein (e.g., plant, light, figurine). In addition, the platform 320 is provided with a plurality of spaced accessory holder slots 340 formed circumferentially on the outer circular edge of the platform 320.

As shown in FIG. 28, the base 322 is attached to the platform 320 using a set of supports 324, such as, for example, a wire, a cable, or a semi-flexible plastic link. Each support 324 is connected at one end to the lower surface of the platform 320. The opposite end of each cable 324 is attached to a tie rod 326 that is fixed to the base 322. In the embodiment shown in FIG. 28, the cables 324 are connected to a single tie rod 326, which is secured in an opening 328 formed centrally in the base 322. It will be appreciated, however, that a plurality of tie rods 326 or hooks may be provided on the base 322 such that each cable 324 is connected to different tie rod 326. Preferably, each cable 324 includes a spring 330 to provide a self adjustment for the platform 320. In this way, the distance between the platform 322 and the base 322 can vary to compensate for changing water levels, for example, under rainy conditions.

The water display stand 310 also includes an optional suspended plate 332 for supporting a pump or other ancillary unit under the platform 320, as shown in FIG. 28. The top surface of the plate 332 includes a guard formed peripherally thereon to prevent the pump from sliding off the plate. The plate 332 is attached to the platform 320 using, for example, support arms or a set of cables 336 that are attached at one end to the plate 332 and at the opposite end to the lower surface of the platform 320. In an alternative embodiment, the supports 324 may be mounted to the plate 332 to secure the platform 320 to the base 322.

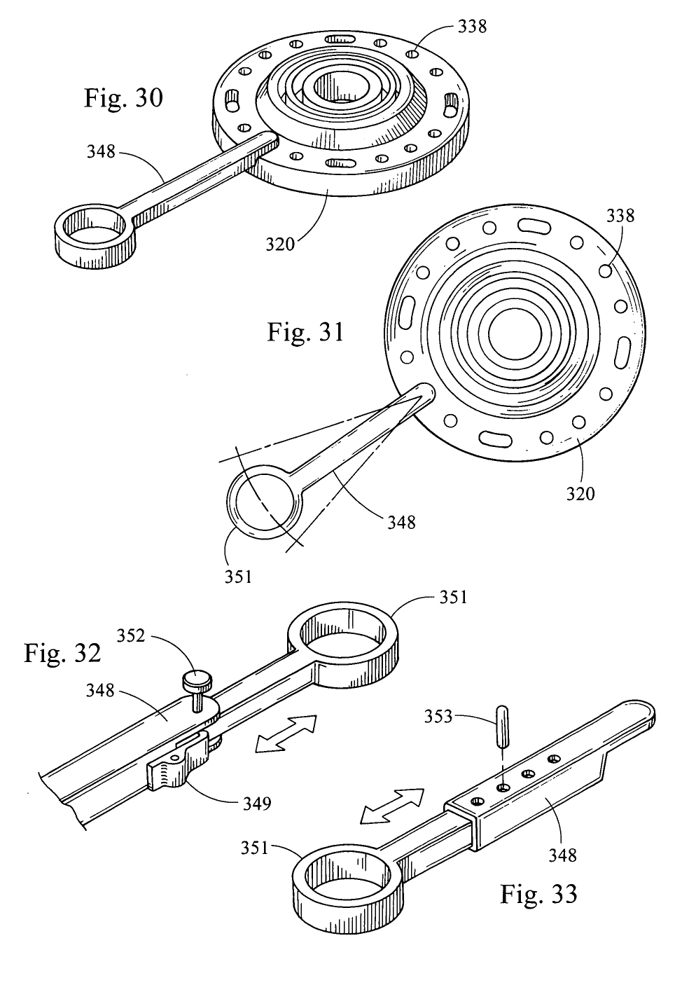

In another floating platform embodiment, as shown in FIGS. 30-31, the platform 320 includes an accessory hole 341 that is dimensioned to pivotally receive a holding member 348. The holding member 348 includes a ring 351 connected to a rigid extension arm. The ring 351 is dimensioned so as to receive various ornamental features therein, for example, a pot for displaying a plant. The distal end of the extension arm is pivotally received in the accessory hole 341 to allow the holding member 348 to swivel relative to the platform 320. It will be appreciated that the extension arm of the holding member 348 may be telescoping to provide an adjustable length for varying the distance of the ring from the platform 320. For example, the telescoping extension arm of the holding member 348 may be provided with a slide mechanism 349 and/or pin arrangement 352 known in the art to adjust the length of the arm and to lock the arm in place, as shown in FIG. 32. Alternatively, the telescoping extension arm may be provided with a snap-lock or detent arrangement 353 for varying the length of the extension arm between a plurality of fixed position, as shown in FIG. 33.

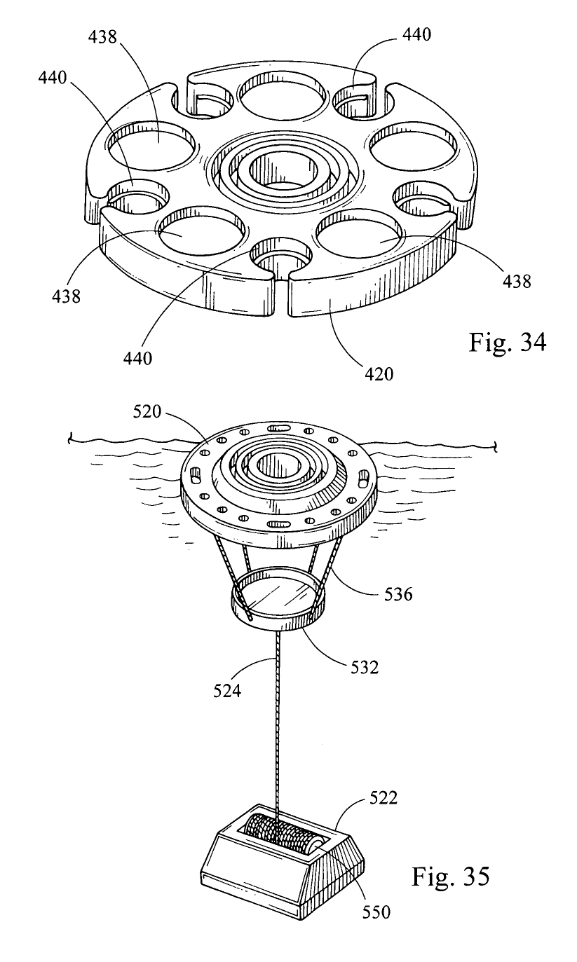

FIG. 34 illustrates another embodiment of a platform 420. The accessory holder slots 440 formed on the platform 420 include slotted circular openings, each of which is provided with a circumferential slotted shelf around its inner bottom edge for supporting accessory devices received in the accessory holder slots 440. In this way, light fixtures having swivel mounts, for example, can be received and positioned in the accessory holder slots 340 to illuminate the fountain or statuette being displayed. The platform 420 also optionally includes accessory holder openings 438.

In another floating platform embodiment, as shown in FIG. 35, a base 522 is attached to a platform 520 using a cable 524 that is wound around a self-winding reel 550 mounted on the base 522. The self-winding reel 550 includes a spring for tensioning the cable 524 against the pull of the buoyancy of the platform 520. In this way, self-winding reel 550 adjusts the length of the cable 524 to maintain the platform 520 in place. The cable 524 is attached to the bottom of a plate 532, which is mounted below the platform 520 by mounting means (e.g., rigid arms, flexible cables, netting) and which may be used for supporting a pump or a display object.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A water display stand comprising:
a platform for supporting a display;
a plurality of adjustable-length legs connected at one end to said platform; and
at least one bayonet means attached to one of a top surface of said platform and said display for selectively engaging a locking member on the other of said top surface and said display.

2. The water display stand of claim 1 wherein said platform includes an opening formed therein and further comprising a pump having a water supply tube extending therefrom through the opening.

3. The water display stand of claim 1 further comprising a display, wherein said display is selected from the group consisting of a fountain, a plant pot, and a statue.

4. The water display stand of claim 1 further comprising at least one accessory holder attached to said platform.

5. A water display stand comprising:
a platform for supporting a display and having at least one arced groove therein configured for selectively engaging a locking member on said display; and
a plurality of legs, each of which has an adjustable length and is connected at one end to said platform.

6. The water display stand of claim 5 wherein said platform includes a buoyant material.

7. The water display stand of claim 5 wherein each of said legs includes a bracket fixed to said one end and said platform includes a socket for receiving said bracket.

8. The water display stand of claim 5 wherein said platform further includes a plurality of arced grooves formed circumferentially therein for selectively engaging a plurality of locking member on said display.

9. The water display stand of claim 8 wherein said platform further includes multiple concentric sets of arced grooves formed circumferentially therein for selectively engaging a plurality of locking member on said display.

10. The water display stand of claim 5 wherein said platform further includes at least one slot formed peripherally thereon for attaching an accessory to said platform.

11. The water display stand of claim 5 wherein said platform includes at least one accessory hole formed in a top surface thereof for attaching an accessory to said platform.

12. The water display stand of claim 5 wherein said platform includes a plurality of stiffening ribs formed on an underside surface thereof.

13. The water display stand of claim 5 wherein said platform includes at least one level indicating structure attached thereto.

14. A water display stand system comprising:
a platform supporting a display, said display being connected in fluid communication with a pump;
a plurality of legs, each of which includes an adjustable length and is connected at one end to said platform;
a plate for supporting said pump; and
means for supporting said plate below said platform.

15. A water display stand system comprising:
a platform; and
a water fountain removably connected to said platform,
wherein said platform is configured to support said water fountain substantially at water level in a body of water.

16. The water display stand of claim 15 wherein said platform is buoyant.

17. The water display stand of claim 16 further comprising a base connected to said buoyant platform for anchoring said platform.

18. The water display stand of claim 15 further comprising a plurality of adjustable legs connected to said platform.

19. The water display stand of claim 15 wherein said platform is configured to be portable for being moved by a user.

20. A water display stand system comprising:
an enclosed body of water having a water level and
a display stand comprising:
an upper platform;
a means for mounting the upper platform to a substrate, said mounting means providing for an adjustable height of the platform relative to the substrate such that the platform is substantially parallel to the water level; and
the upper platform comprising a bayonet means for mounting a removable display thereto.
